(19) United States
(12) Patent Application Publication
(10) Pub. No.: US 2005/0268233 A1
(43) Pub. Date: Dec. 1, 2005

(54) System and method for mixed language editing

(75) Inventors: Jesse Perla, New York City, NY (US); Oleg Dulin, Staten Island, NY (US); Vishvas T. Canaran, Jacksonville, FL (US)

Correspondence Address: HOWREY LLP, C/O IP DOCKETING DEPARTMENT, 2941 FAIRVIEW PARK DR, SUITE 200, FALLS CHURCH, VA, 22042-2924, US

(73) Assignee: ConfigureCode, Inc.

(21) Appl. No.: 10/834,878

(22) Filed: Apr. 30, 2004

(51) Int. Cl. G06F 7/00

(52) U.S. Cl. 715/703

(57) ABSTRACT

An embodiment of the invention generally relates to a method of processing data. The method includes parsing a multi-language document and determining a plurality of languages for the multi-language document. The method also includes retrieving associated configuration information based on the plurality of languages and generating a visual representation of the multi-language based on the associated configuration information.

### CROSS-REFERENCE TO RELATED APPLICATIONS

This application is related to U.S. patent application Ser. No. 10/______, entitled “System and Method For Document and Data Validation”, filed concurrently and is hereby incorporated in its entirety.

### FIELD OF THE INVENTION

Embodiments of the present invention generally relate to document editing, more particularly, the visual editing of mixed-language documents.

### BACKGROUND OF THE RELATED ART

The World Wide Web Consortium (W3C) was founded with the intention of managing evolution of the World Wide Web (“Web”). From the beginning, the vision of the W3C has always had the idea of “The Semantic Web” as a way to provide machine-readable documents and applications on the Web.

A recently emerging problem with the structure of web pages in the Web was the merging of presentation and content. In theory, developers were supposed to write Hypertext Markup Language (“HTML”) pages with cascading stylesheets (“CSS”) that provided the layout and presentation rules. The developers, instead, typically wrote a combination of HTML with embedded style and layout, CSS rules for certain elements and user defined classes, and JavaScript/DHTML to modify much of the display dynamically. The separation between presentation and content is becoming increasingly important as the Web expands to include more diverse devices and user agents and auditory access.

Extensible Markup Language (“XML”) is a possible solution to the problem of separation of presentation and content since users can write their own tags and attach CSS or Extensible Stylesheet Transformation (“XSLT”) styling to these custom tags. However, XML has several disadvantages or drawbacks. For example, one problem is moving to XML is a major technology and training leap for move from a fixed tag language such as HTML. Software developers are used to this sort of rigorous levels of specification, but many authors, client side developers, webmasters, and information architects, i.e., non-software developers, have enough trouble with HTML and its variants. To aid in the transition process, the W3C introduced Extensible Hypertext Markup Language (“XHTML”) as an intermediary to help non-developers move from HTML to XML. It is common belief that XHTML is an ephemeral transitional technology while others consider that most non-developers will use XHTML than directly writing XML content. Regardless, it is becoming clear that XML makes possible new tools and new development approaches for the Web.

As the new XML technologies emerge, the development process is evolving to allow a division between content and presentation. The content developers are beginning to use XML based content authoring tools that allow for creation of structured content without forcing style to denote structure. The graphic designers are beginning to choose tools to define and layout the CSS and adaptable graphics. The developers now have tools to create schemas and edit XML as structured trees of data.

However, the XML authoring tools may still have their drawbacks and disadvantages. For example, many software developers are using markup languages for the first time. More specifically, many developers are familiar with procedural programming language such as COBOL. These ex-COBOL developers may experience a large learning curb adapting to Java, J2EE, XML, HTML, and all the technologies they may (or may not) need to create the applications. In particular, if they are creating XML based user interfaces and forms (as opposed to XML data transformations and access) they may need to write in many different markup languages. While some of the markup languages may only include a couple of relevant tags for any given XML user interface, nevertheless, a developer needs to potentially consider 25 different languages or standards. Moreover, for each of the markup language, the developer needs to consider relevant modules (e.g. XHTML strict vs. transitional, CSS mobile profiles, etc.) for the target user agent.

Moreover, these procedural language developers have to be cognizant of building user interfaces for their programs. Although current XML technologies assist the developers to build structured XML files, define and transform XML schemas, and write specialized formats, the current XML technologies create mixed language documents. The process of creating structured XML data does not assist these developers build dynamic user interfaces.

The procedural language developers have traditionally stayed away from “what you see is what you get” (“WYSIWYG”) user interfaces due to a combination of software developer philosophy and poor tooling. Historically, software design philosophy states that “real” developers use text-based operating systems like UNIX and esoteric tools, e.g., EMACS or CodeWright. However, the proliferation of graphical operating systems and programs has initiated a conversion from text-based tools to graphic-based tools. For example, the conversion from using text based operating systems to GUI driven Windows, Linux/Gnome, and Macintosh is driving developers to build graphic user interfaces (GUI). Another example is the move from text based document editing in EMACS to an Integrated Development Environments (“IDE”) like Microsoft Visual Studio or Borland JBuilder. Yet another example is the move to WYSIWYG tools for designing Client-Server form applications like Visual Basic, Delphi, Oracle Forms, and JavaBeans.

However, with all of these advancements developers still tend to shun WYSIWYG tools for designing user interfaces for web-based technologies. The primary reason being that Web WYSIWYG tooling is modeled on word processors and is targeted primarily at authors and Web designers producing content for the Web. Developers, on the other hand, need finer control and do not require the superfluous code generated by conventional WYISWYG tools. Developers also are creating very dynamic applications that by their very nature are difficult to render as WYSIWYG. Clearly, developers need a tool which fits into their existing IDE frameworks and enables graphical development of mixed-language XML stylesheets and web pages.

### SUMMARY OF THE INVENTION

An embodiment of the invention generally relates to a method of processing data. The method includes receiving a multi-language document and generating a source model of the multi-language document. The method also includes determining a plurality of languages associated with the multi-language document and determining an associated transformation for each of the plurality of languages. The method further includes generating a visual representation of the multi-language document based on the associated transformations.

Another embodiment of the invention generally pertains to a method for processing data. The method includes parsing a multi-language document and determining a plurality of languages for the multi-language document. The method also includes retrieving associated configuration information based on the plurality of languages and generating a visual representation of the multi-language document based on the associated configuration information.

Yet another embodiment generally relates to a system for processing data. The system includes a document viewer configured to display documents and an editor module configured to interface with the document viewer. The editor module is configured to parse a multi-language document and to determine a plurality of languages for the multi-language document. The editor module is also configured to retrieve associated configuration information based on the plurality of languages and generate a visual representation of the multi-language based on the associated configuration information.

Yet another embodiment generally relates to a computer readable storage medium on which is embedded one or more computer programs. The one or more computer programs implement a method of processing data. The one or more computer programs include a set of instructions for receiving a multi-language document and generating a source model of the multi-language document. The one or more computer programs include a set of instructions for determining a plurality of languages associated with the multi-language document and determining an associated transformation for each of the plurality of languages. The one or more computer programs further include a set of instructions for generating a visual representation of the multi-language document based on the associated transformations.

### BRIEF DESCRIPTION OF THE DRAWINGS

While the specification concludes with claims particularly pointing out and distinctly claiming the present invention, it may be believed the same will be better understood from the following description taken in conjunction with the accompanying drawings, which illustrate, in a non-limiting fashion, the best mode presently contemplated for carrying out the present invention, and in which like reference numerals designate like parts throughout the figures, wherein:

FIG. 1 illustrates a system in accordance with an embodiment of the invention;

FIG. 2 illustrates a block diagram of an architecture for the editor module in accordance with another embodiment;

FIG. 3 illustrates a flow diagram for the editor module shown in FIG. 1 in accordance with yet another embodiment of the invention;

FIG. 4 illustrates another flow diagram for the editor module shown in FIG. 1 in accordance with yet another embodiment of the invention;

FIG. 5 illustrates yet another flow diagram for the editor module shown in FIG. 1 in accordance with yet another embodiment of the invention; and

FIG. 6 illustrates a computer system implementing the editor module in accordance with yet another embodiment.

### DETAILED DESCRIPTION OF THE EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, many types of document editing systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments of the present invention generally relate to methods and systems for editing mixed language documents for WYSIWYG applications. More specifically, an editor module may be configured to receive a source document and create a source model for the source document. The editor module may also be configured to determine the number of languages that are used in the source document. In some embodiments, the editor module uses name spaces and/or document type definitions (“DTD”) declarations as a mechanism to determine the languages for the source document.

The editor module is further configured to determine the appropriate transformations for each of the languages to create an XSLT stylesheet that is subsequently used to create an XHTML representation of the source document. More specifically, the editor module may also be configured to apply the XSLT stylesheet to the source model of the document to generate the XHTML representation. In one embodiment of the invention, the transformations are configured to embed a return path tag, e.g., an “xpath” attribute, within the generated XHTML representation for each element to provide a method to return to the original element. The editor module is further configured to provide the XHTML to appropriate software for display, e.g., a web browser.

In other embodiments, a user may edit the displayed XHTML representation through a conventional manner. The editor module may receive a user input command to select a node for editing by a mouse action. The editor module may be configured to receive the editing changes for the selected node from a keyboard. The editor module may then be configured to apply the editing changes to the source document by using the appropriate return path marker for the selected node. Subsequently, the editor module may modify the XSLT stylesheet for the source document to reflect the received changes for display.

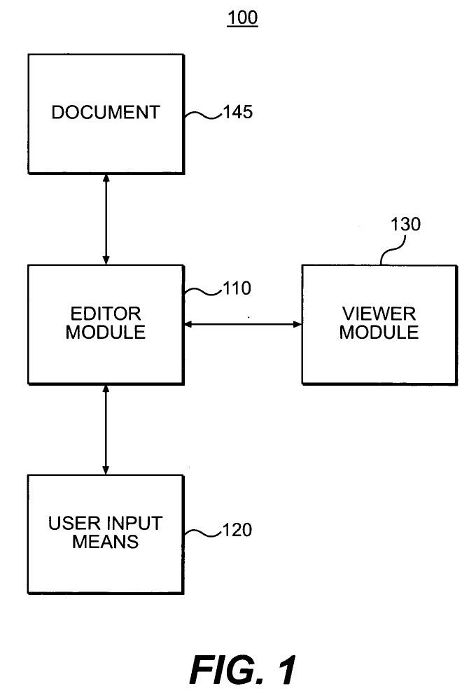

FIG. 1 illustrates a block diagram for a mixed-language editing system 100 in accordance with an embodiment of the invention. It should be readily apparent to those of ordinary skill in the art that the mixed-language editing system 100 depicted in FIG. 1 represents a generalized schematic illustration and that other components may be added or existing components may be removed or modified. Moreover, the mixed-language editing system 100 may be implemented using software components, hardware components, or a combination thereof.

As shown in FIG. 1, the mixed-language editing system 100 includes an editor module 110, a user input means 120, and a viewer module 130. The editor module 110 may be configured to provide a user a mechanism to create and/or edit mixed-language documents. The mixed-languages may be selected from XML, HTML, Java, CSS, etc. The editor module 110 may also provide a mechanism for developers to develop WYISWIG graphical user interfaces (GUI) utilizing mixed-languages in a single development environment.

The user input means 120 may be configured to provide a mechanism and/or means for a user to interact with the mixed-language editing system 100. For example, by keying appropriate commands through the user input means 120, a user may load, edit, display, program, and/or enter a mixed language document. In some embodiments, the user input means 120 may be implemented with a keyboard, a mouse, a trackball, other interface known in the art or some combination thereof.

The editor module 110 may be configured to interface with the viewer module 130. The viewer module 130 may be configured to provide a mechanism and/or means to display a document. The viewer module 130 may be a conventional viewer such as CanvasViewer or may be a custom-built software module to display XHTML representations of documents.

In some embodiments, a user may invoke the appropriate command through the user inputs means to load a document 145 into the editor module 110. The document 145 may be retrieved from local memory of the computing platform, e.g., a personal computer, a workstation, a terminal, etc. Alternatively, the document 145 may be retrieve from a remote location over a local area network, a wide area network, or some combination thereof.

A user may invoke another command, e.g., command, menu prompt, etc., for the editor module 110 to create a source model from the document 145. The editor module 110 may also be configured to parse the document 145 to determine the number of languages that are used in the source document. In some embodiments, the editor module 110 uses name spaces and/or document type definitions (“DTD”) declarations as a mechanism to determine the languages for the source document.

The editor module 110 may be further configured to use the configuration model to determine the appropriate transformations for each of the languages to create an XSLT stylesheet. The configuration model may be, but not limited to being, configured to manage the mapping of namespace/DTD declarations to XSLT transformations. In certain embodiments, the configuration model may be implemented as a look-up table, a linked list, or other similar data structure. The transformations convert an element of the respective element into an XHTML representation for that element. In other embodiments, the transformations may be configured to embed a return path tag, e.g., for the element. The editor module 110 may be further configured to apply the generated XSLT stylesheet to the source model of the document 145 to generate the XHTML representation for the viewer module 130.

A user may invoke yet another command through the user input means 120 to edit the document 145 in the mixed-language editing system 100. The user may select a node in the displayed XHTML representation of document 145 by highlighting the node by the user input means 120, e.g., a mouse, keyboard, etc.

The user may input editing changes through the user input means 120 for the selected node. The editor module 110 may be configured to receive the editing changes for the selected node. The editor module 110 may then be configured to apply the editing changes to the source document by using the appropriate return path marker for the selected node. Subsequently, the editor module 110 may modify the XSLT stylesheet for the source document to reflect the received changes for display.

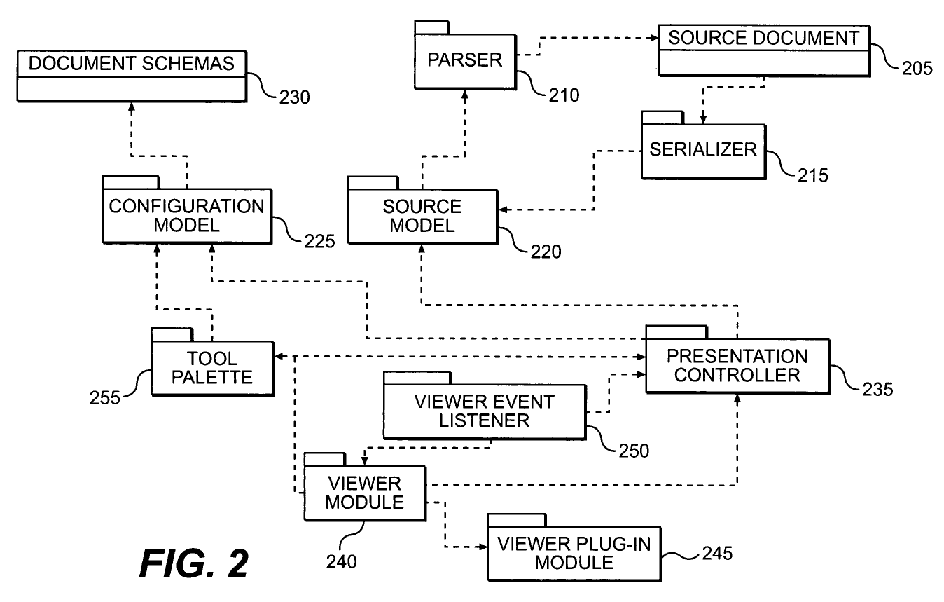

FIG. 2 illustrates a block diagram for the architecture of the editor module 110, shown in FIG. 1, in accordance with another embodiment of the invention. It should be readily apparent to those of ordinary skill in the art that the editor module 110 depicted in FIG. 2 represents a generalized schematic illustration and that other components may be added or existing components may be removed or modified. Moreover, the editor module 110 may be implemented using software components, hardware components, or a combination thereof.

As shown in FIG. 2, the editor module 110 includes a source document 205, a parser 210, a serializer 215, a source model 220, a configuration model 225, a document schema module 230, a presentation controller 235, a viewer module 240, a viewer plug-in 245, a viewer event listener 250, and a tool palette module 255.

The source document 205 may be underlying file on disk or in memory that is to be edited. The source document 205 may be XML or be in a near-XML language, e.g., HTML, JSP. The capability of the editing module 110 to be compatible with languages may be dependent on the parser 210 and the source model 220.

The parser 210 may be configured, but not limited to, for turning the bytes of the source document 205 into tokens and structures for the source model 220. In some embodiments, the parser 210 may be implemented with conventional parsers, e.g., Apache Xerces SAX parser. In other embodiments, the parser 210 may be implemented with custom-built parsers.

The serializer 215 may be configured, but not limited to, for turning the tokens and structures of the source model 220 into bytes of a file. The serializer 215 may be implemented with conventional serializers, e.g., Apache Xerces libraries or with a custom built-serializer that is complementary to a custom-built parser 210.

The source model 220 may be, but is not limited to being, configured to be tightly coupled with the serializer 215 and the parser 210. The source model 220 may also be configured to provide a data structure that represents the source document 205 in programmatic data structures, e.g., trees, arrays, or other similar construct. In some embodiments, when the parser is a conventional parser, the source model 220 may be implemented with an industry standard model, e.g., W3C DOM. In other embodiments, customized data structures in the source model 220 along with customized parsers 205 and serializers 210 may provide for greater flexibility in processing non-XML documents and maintaining information not contained in an industry standard data structure.

The configuration model 225 may be, but is not limited to being, configured to contain a set of files for each underlying language that provides metadata. The configuration model 225 may also be configured to contain the visual representation of XML elements and attributes for the system 100, shown in FIG. 1. The configuration model 225 may be based on information contained in document schema module 230. However, the visual representation of the document will be an associated transformation fragment. Accordingly, the configuration model 225 may also contain transformation fragments, each transformation fragment may be associated with a supported language and/or schema. The transformation fragments convert the supported language to a single predetermined output format, e.g., XHTML. The transformation may be written in a variety of imperative or declarative languages. For example, in one embodiment, XSLT fragments that generate XHTML/CSS are used for the transformation fragments.

The document schema module 230 may be configured to store the schemas for each language, e.g., XHTML, XSLT, XFORMS, etc., supported by the editor module 110. The schemas stored in the document schemas 230 may support a variety of industry standard languages, W3C XML schema, RelaxNG, DTD (“document type definitions”), etc. The schemas provide supplemental information to the configuration model 225.

The presentation controller 235 may be, but not limited to being, configured to processing the aggregated visual transformations from the configuration module 225 for all of the relevant languages use in the source document 205. The presentation controller 235 may also be configured to apply the transforms of XSLT stylesheet to the source model 220 to create the aggregated visual representation in a standard language, e.g., XHTML.

The viewer module 240 may be configured, but not limited to being, configured to manage the display of the visual representation of the document 145 (shown in FIG. 1) through the viewer plug-in module 245. The viewer module 240 may also be configured to manage the WYISWIG changes in the viewer plug-in module 245 though the viewer event listener module 250. The viewer module 240 may be implemented with a conventional viewer such as CanvasView in some embodiments or with a custom-built viewer in other embodiments.

The viewer plug-in module 245 may be configured as a library of plug-ins. A plug-in may be web browser components that can display the visual representation in standard languages such as HTML/CSS. The plug-in may also permit inline, WYSIWYG, editing of the underlying information in the view. The plug-ins may communicate changes back to the viewer module 240 through the viewer listener module 250 by using Javascript, Internet Explorer's designmode, etc.

The viewer event listener module 250 may be configured to abstract the different methods that the viewer plug-in module 245 communicates the WYSIWYG changes to the XHTML representation of the document 145 (shown in FIG. 1) back to the underlying source document 220. The viewer module 240 may then manage the communication of the events back to the source model 220 and alters the data structures therein.

The tool palette module 255 may be configured to permit users to make changes to the source document 205 outside of the viewer plug-in module 245. For example, a user may want to click on a toolbar item to add a new element or delete an existing element to the source document 205. The tool palette module 255 may communicate the changes to the source model 220 through the viewer module 240. In some embodiments, the tool palette module 255 may use the configuration model 225 and the document schema module 230 to present users with schema-driven choices.

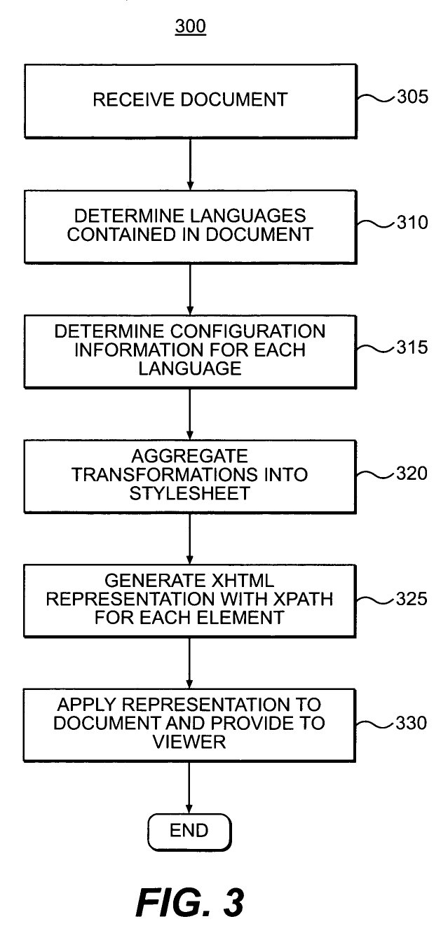

FIG. 3 illustrates a flow diagram 300 for loading and displaying a document for the editor module 110, shown in FIG. 2, in accordance with yet another embodiment. It should be readily apparent to those of ordinary skill in the art that this flow diagram 300 represents a generalized illustration and that other steps may be added or existing steps may be removed or modified.

As shown in FIG. 3, a user may invoke the editor module 110 to receive a document. For example, a user may invoke a command on a menu or enter a command line prompt to load the document into the editor module 110. The editor module 110 may also be configured to parse the document using the parser 210 and to create the appropriate the data structures for the source model 220.

In step 310, the presentation controller module 235 may be configured to determine the languages used in the document. More specifically, the presentation controller module 235 may query for the configuration model 225 for the languages used in the document.

In step 315, the presentation controller module 235 may query the configuration model 225 for the appropriate transformations for the determined languages. In some embodiments, the configuration model 225 may provides a lookup tables for the different languages to find both the schemas and the XSLT fragments used for the transformation.

In step 320, the configuration model 225 may be configured to determine the appropriate transformations for each language In step 325, the configuration model 225 may be configured to aggregate the transformations for each language into an XSLT stylesheet, which will be used to create the XHTML representation of the document. The XSLT transformation will also embed an return path attribute, e.g., xpath, within the generated XHTML representation for each element to provide a mechanism to return the location of the original element in the source document.

In step 330, the presentation controller module 235 may be configured to apply the XSLT stylesheet to the source model 220 to create the XHTML representation with the embedded return path tags.

In step 335, the presentation controller module 235 may be configured to forward the XHTML representation to the viewer module 240 for display to a user. The viewer module 240 may invoke the viewer plug-in module 245 to display the XHTML representation for the user. Subsequently, the editor module 110 may terminate this processing.

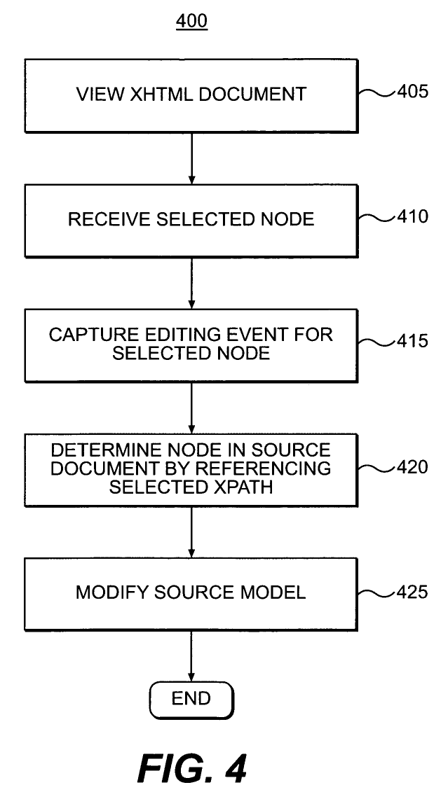

FIG. 4 illustrates a flow diagram 400 for editing a document for the editor module 110, shown in FIG. 2, in accordance with yet another embodiment. It should be readily apparent to those of ordinary skill in the art that this flow diagram 400 represents a generalized illustration and that other steps may be added or existing steps may be removed or modified.

As shown in FIG. 4, in step 405, a user may display the XHTML representation of a document on the display device of a computing platform executing the editor module 110. In step 410, a user may select a node for editing by using the user input means 120 (see FIG. 1).

In step 415, the viewer listening module 250 may be configured to capture a typing event for the selected node and pass the change to the presentation controller module 235 as a change to the source model 220.

In step 420, the viewer listening module 250 may be configured to determine the appropriate node in the source document 205 by referencing the return path tag in the edited element.

In step 425, the presentation controller module 235 may invoke methods and tree operations to propagate the changes in the source model 220. More specifically, an application program interface for the source model may be used to modify the data structures. Subsequently, the presentation controller module 235 may reflect the changes in the source model 220 by executing the steps of flow diagram 300 (shown in FIG. 3) and described herein above.

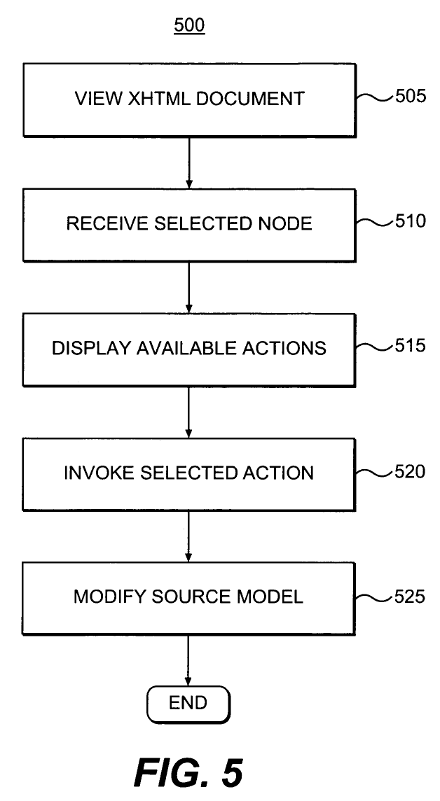

FIG. 5 illustrates a flow diagram 500 for editing with a tool palette module 255, shown in FIG. 2, in accordance with yet another embodiment. It should be readily apparent to those of ordinary skill in the art that this flow diagram 500 represents a generalized illustration and that other steps may be added or existing steps may be removed or modified.

As shown in FIG. 5, in step 505, a user may display the XHTML representation of a document on the display device of a computing platform executing the editor module 110. In step 510, a user may select a node for editing by using the user input means 120 (see FIG. 1).

In step 515, the tool palette module 255 may display a menu of actions available for a user, e.g., available children and siblings. The menu of actions available may be cased on the configuration model 225 and the document schema module 230 by querying the appropriate schema for the language. For example, XHTML has a <html:ol> element which is used for ordered lists of items. The children within it are usually <html:li> elements. The acceptable children can be determined from the schema, and the appropriate schema for a language can be determined from the configuration model.

In step 520, for the selected action, the tool palette module 255 performs the action with the related return path tag for the selected node. For example, if the action available is adding a sibling, the sibling and the return path tag for the selected node are forwarded to the presentation controller 235 by the tool palette module 255.

In step 525, the presentation controller module 235 may invoke methods to modify changes in the source model 220 by invoking methods and tree operations to propagate the changes in the source model 220. More specifically, an application program interface for the source model may be used to modify the data structures. Subsequently, the presentation controller module 235 may reflect the changes in the source model 220 by executing the steps of flow diagram 300 (shown in FIG. 3) and described herein above.

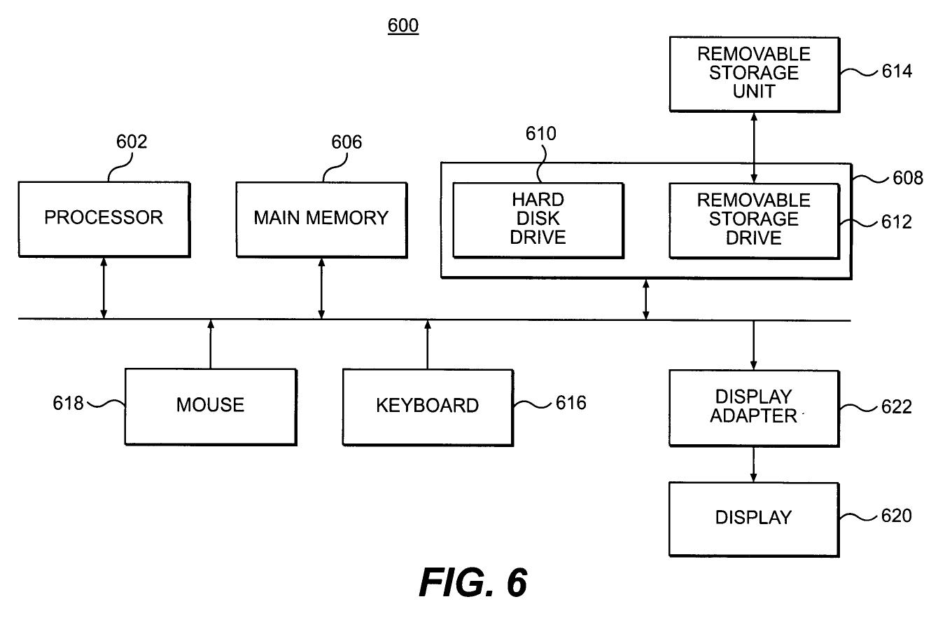

FIG. 6 illustrates a computer system implementing the mixed language editing system 100 in accordance with yet another embodiment of the invention. The functions of the mixed language editing system 100 may be implemented in program code and executed by the computer system 600. The mixed language editing system 100 may be implemented in computer languages such as C#, C, C++, JAVA, etc.

As shown in FIG. 6, the computer system 600 includes one or more processors, such as processor 602, that provide an execution platform for embodiments of the mixed language editing system 100. Commands and data from the processor 602 are communicated over a communication bus 604. The computer system 600 also includes a main memory 606, such as a Random Access Memory (RAM), where the software for the mixed language editing system 100 may be executed during runtime, and a secondary memory 608. The secondary memory 608 includes, for example, a hard disk drive 610 and/or a removable storage drive 612, representing a floppy diskette drive, a magnetic tape drive, a compact disk drive, or other removable and recordable media, where a copy of a computer program embodiment for the mixed language editing system 100 may be stored. The removable storage drive 612 reads from and/or writes to a removable storage unit 614 in a well-known manner. A user interfaces with the mixed language editing system 100 with a keyboard 616, a mouse 618, and a display 620. The display adaptor 622 interfaces with the communication bus 604 and the display 620 and receives display data from the processor 602 and converts the display data into display commands for the display 620.

Certain embodiments may be performed as one or more computer programs. The computer program may exist in a variety of forms both active and inactive. For example, the computer program can exist as software program(s) comprised of program instructions in source code, object code, executable code or other formats; firmware program(s); or other known program. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals arriving from the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

1. A method of processing data, the method comprising:
receiving a multi-language document;
generating a source model of the multi-language document;
determining a plurality of languages associated with the multi-language document;
determining an associated transformation for each of the plurality of languages; and
generating a visual representation of the multi-language document based on the associated transformations.

2. The method according to claim 1, further comprising:
generating a stylesheet based on the plurality of associated transformation.

3. The method according to claim 2, further comprising:
applying the stylesheet to the source model to generate the visual representation; and
providing the visual representation to a document viewer.

4. The method according to claim 2, further comprising:
embedding a return path marker for each associated transformations of the plurality of transformation.

5. The method according to claim 3, further comprising:
editing the visual representation of the multi-language document through the document viewer; and
capturing the edits as an event.

6. The method according to claim 5, further comprising:
mapping the edits through the return path marker to the source model; and
applying the edits to the source model.

7. The method according to claim 6, further comprising:
applying the associated transformations to the edited source model to generate a visual representation of the edited source model.

8. The method according to claim 1, further comprising:
storing configuration files, each configuration file defining elements and attributes of each language of the plurality of languages.

9. The method according to claim 7, further comprising:
parsing the multi-language document;
selecting an associated configuration file for each language of the plurality of languages; and
applying the associated configuration file in generating the visual representation of the multi-language document.

10. A method of processing data, the method comprising:
parsing a multi-language document;
determining a plurality of languages for the multi-language document;
retrieving associated configuration information based on the plurality of languages; and
generating a visual representation of the multi-language document based on the associated configuration information.

11. The method according to claim 10, further comprising:
determining the associated configuration information based on at least one of detected namespaces and document type definition declaration contained in the multi-language document.

12. The method according to claim 11, further comprising:
determining associated transformations for each language of the plurality of language; and
aggregating the associated transformation on a stylesheet.

13. The method according to claim 12, further comprising:
embedding a return path marker for each element by each associated transformation in generating the visual representation.

14. The method according to claim 13, further comprising:
creating at least one data structure to form a source model based on the parsing of the multi-language document.

15. The method according to claim 14, further comprising:
applying the stylesheet to the source model to generate the visual representation.

16. The method according to claim 10, further comprising:
creating at least one data structure to form a source model based on the parsing of the multi-language document.

17. The method according to claim 16, further comprising:
selecting a node on the visual representation of the multi-language document; and
receiving an editing event for the node.

18. The method according to claim 17, further comprising:
forwarding the editing event to based on the respective return path tag for the node; and
modifying the source model based on the editing event.

19. A system for processing data, the system comprising:
a document viewer configured to display documents; and
an editor module configured to interface with the document viewer, wherein the editor module is configured to parse a multi-language document, determine a plurality of languages for the multi-language document, retrieve associated configuration information based on the plurality of languages, and generate a visual representation of the multi-language based on the associated configuration information.

20. The system according to claim 20, wherein the editor module is further configured determine the associated configuration information based on at least one of detected namespaces and document type definition declaration contained in the multi-language document.

21. The system according to claim 21, wherein the editor module is further configured to determine the associated transformations for each language of the plurality of language and to aggregate the associated transformation on a stylesheet.

22. The system according to claim 21, wherein the editor module is further configured to embed a return path marker for each element by each associated transformation in generating the visual representation for display on the document viewer.

23. The system according to claim 22, wherein the editor module is further configured to create at least one data structure to form a source model based on the parsing of the multi-language document.

24. The system according to claim 23, wherein the editor module is further configured to apply the stylesheet to the source model to generate the visual representation on the document viewer.

25. The system according to claim 19, wherein the editor module is further configured to create at least one data structure to form a source model based on the parsing of the multi-language document.

26. The system according to claim 25, the system further comprising:
a user input means configured to allow a user to select a node on the visual representation of the multi-language document on the document viewer and the editor module is further configured to receive an editing event for the node.

27. The system according to claim 26, wherein the editor module is further configured to forward the editing event to based on the respective return path tag for the node and to modify the source model based on the editing event.

28. A computer readable storage medium on which is embedded one or more computer programs, the one or more computer programs implementing a method of processing data, the one or more computer programs comprising a set of instructions for:
receiving a multi-language document;
generating a source model of the multi-language document;
determining a plurality of languages associated with the multi-language document;
determining an associated transformation for each of the plurality of languages; and
generating a visual representation of the multi-language document based on the associated transformations.

29. The one or more computer programs according to claim 28 further comprising a set of instructions for:
generating a stylesheet based on the plurality of associated transformation.

30. The one or more computer programs according to claim 27, further comprising a set of instructions for:
applying the stylesheet to the source model to generate the visual representation; and
providing the visual representation to a document viewer.

31. The one or more computer programs according to claim 29, further comprising a set of instructions for embedding a return path marker for each associated transformations of the plurality of transformation.

32. The one or more computer programs according to claim 3, further comprising a set of instructions for:
editing the visual representation of the multi-language document through the document viewer; and
capturing the edits as an event.

33. The one or more computer programs according to claim 32, further comprising a set of instructions for:
mapping the edits through the return path marker to the source model; and
applying the edits to the source model.

34. The one or more computer programs according to claim 33, further comprising a set of instructions for applying the associated transformations to the edited source model to generate a visual representation of the edited source model.

35. The one or more computer programs according to claim 28, further comprising a set of instructions for storing configuration files, each configuration file defining elements and attributes of each language of the plurality of languages.

36. The one or more computer programs according to claim 35, further comprising a set of instructions for:
parsing the multi-language document;
selecting an associated configuration file for each language of the plurality of languages; and
applying the associated configuration file in generating the visual representation of the multi-language document.
